(19) United States
(12) Patent Application Publication
(10) Pub. No.: US 2024/0255744 A1
(43) Pub. Date: Aug. 1, 2024

(54) BEAM EXPANDING PLANAR WAVEGUIDE ILLUMINATION

(71) Applicant: BEYEONICS VISION LTD., Haifa (IL)

(72) Inventor: Itzhak BAUM, Haifa (IL)

(73) Assignee: BEYEONICS VISION LTD., Haifa (IL)

(21) Appl. No.: 18/426,468

(22) Filed: Jan. 30, 2024

Related U.S. Application Data
(60) Provisional application No. 63/482,090, filed on Jan. 30, 2023.

(51) Int. Cl. G02B 21/00; G02B 21/22

(52) U.S. Cl. CPC G02B 21/0032; G02B 21/22

(57) ABSTRACT

Systems and methods for coaxial illumination and observation are provided herein. The systems and methods may include a beam expanding planar waveguide configured to direct light along an optical axis defined by optical elements of an optical device, and towards a target.

### CROSS REFERENCE TO RELATED APPLICATIONS

The application claims the benefit of U.S. Provisional Patent Application No. 63/482,090, filed on Jan. 30, 2023, which is incorporated herein by reference in its entirety.

### FIELD OF THE INVENTION

The present invention relates generally to optical devices with coaxial illumination of a target or object.

### BACKGROUND OF THE INVENTION

In the field of optical devices, it may sometimes be desired to provide coaxial illumination, in other words, illumination that is parallel and centered with the optical line of sight. For example, in ophthalmic surgery, coaxial illumination may be required to generate a reflection from a retina (e.g., sometimes referred to as the ‘red eye effect’ or ‘red reflex’) that may be visible to a viewer. This may enable the viewer to see anatomical tissues within the eye that may otherwise not be visible. In traffic control, a license-plate reader may benefit from coaxial illumination in order to benefit from the retro-reflection effect of a license plate, such that the license plate may be seen clearly. Coaxial illumination may also be beneficial in order to illuminate a narrow cavity, which may be difficult or impossible to illuminate sufficiently with conventional means, such as a flashlight. Coaxial illumination may also reduce shade effects in an image, when compared to non-coaxial illumination.

FIG. 1 shows a conventional illumination setup with a beam splitter (20) as disclosed in U.S. Pat. No. 8,523,359. The conventional setup involves a number of disadvantages. Firstly, given that the transmission and reflection sum is at most 100%, for a high image channel, the illumination must be low. This causes most of the light to be wasted and gives a maximal efficiency of 25%. Secondly the beam splitter may be required to be particularly large. For a beam of diameter D, the size of the beam splitter is typically a volume of D\hat{ }3 (D cube). When the optical device is close to the object, for example when using a microscope, the size of the beam splitter forces a larger distance between the optical device and the object, which reduces the optical device's magnification.

### SUMMARY OF THE INVENTION

Some embodiments of the invention may improve illumination technology by providing coaxial illumination devices and methods, which, for example, have a compact physical size, allow for clear viewing of retroreflectors, are particularly effective at detecting light reflected at 90 degrees, which are particularly effective at viewing targets inside narrow cavities (e.g., viewing a surgical site in a mini-open procedure, such as a mini-open spine procedure or a deep brain procedure), and are particularly effective when searching for targets that comprise retroreflectors (e.g., the eyes of certain animals, and lifejackets).

Some aspects of the invention may be directed to a method of illuminating an object along an optical axis defined by optical elements of an optical device, wherein the method may involve: directing the optical axis of the optical device at the object; placing a beam expanding planar waveguide between the optical device and the object; and directing a light beam of an illumination source at the beam expanding planar waveguide at an entrance aperture thereon, such that the beam expanding planar waveguide transmits a significant portion of the energy of said light beam onto the object along the optical axis of the optical device.

Some aspects of the invention may be directed to a coaxial illumination system, wherein the system may include: an optical device having optical elements defining an optical axis, said optical device being directed at an object located along the optical axis; a beam expanding planar waveguide placed between the optical device and the object; and an illumination source configured to direct a light beam at the beam expanding planar waveguide at an entrance aperture thereon, such that the beam expanding planar waveguide transmits a significant portion of the energy of said light beam onto the object along the optical axis of the optical device.

Some aspects of the invention may be directed to a method of illuminating an object along an axis defined by energy focusing elements of an electromagnetic device, wherein the method may involve: directing the axis of the electromagnetic device at the object; placing a beam expanding planar waveguide between the electromagnetic device and the object; and directing an electromagnetic beam of an electromagnetic source at the beam expanding planar waveguide at an entrance aperture thereon, such that the beam expanding planar waveguide transmits a significant portion of the energy of said electromagnetic beam onto the object along the axis of the electromagnetic device.

### BRIEF DESCRIPTION OF THE DRAWINGS

The subject matter regarded as the invention is particularly pointed out and distinctly claimed in the concluding portion of the specification. The invention, however, both as to organization and methods of operation, together with objects, features, and advantages thereof, may best be understood by reference to the following detailed description when read with the accompanying drawings in which:

FIG. 1 shows a conventional prior art illumination setup with a beam splitter according to the prior art.

FIG. 2 shows a coaxial illumination device according to some embodiments of the present invention.

FIG. 3 shows a coaxial illumination device according to some embodiments of the present invention.

FIG. 4 shows a coaxial illumination device according to some embodiments of the present invention.

FIG. 5 shows a coaxial illumination device according to some embodiments of the present invention.

FIG. 6 shows a coaxial illumination device, with a view of a waveguide entrance aperture, according to some embodiments of the present invention.

FIG. 7 shows a coaxial illumination device, with a view of a waveguide entrance aperture, according to some embodiments of the present invention.

FIG. 8 shows a coaxial illumination device, with a view of a waveguide entrance aperture, according to some embodiments of the present invention.

FIGS. 9A and 9B show beam expansion apparatuses which include lasers according to some embodiments of the present invention.

FIGS. 10A, 10B, and 10C show a number of coaxial illumination devices with different relative positions of the optical device with respect to the waveguide.

FIGS. 11A and 11B show examples of waveguides according to some embodiments of the present invention.

FIGS. 12A and 12B show naked-eye illumination devices according to some embodiments of the present invention.

FIGS. 13A and 13B show loupe illumination devices according to some embodiments of the present invention.

FIGS. 14A, 14B, and 14C show telescopic illumination devices according to some embodiments of the present invention.

FIGS. 15A and 15B show example use cases of coaxial illumination devices 200 according to some embodiments of the invention.

FIGS. 16A and 16B show coaxial radar and radio devices according to some embodiments of the present invention.

### DETAILED DESCRIPTION OF THE INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

As used herein, “beam expanding planar waveguide”, or simply “planar waveguide”, “waveguide”, or “planar optical element” may refer to a device configured to receive a light beam with a small width and/or from a source with a small aperture, and expand the width of the light beam, such that a light beam emitted from a waveguide has a wider beam width than the light beam received by the waveguide. The waveguide may preserve other properties of the output light beam with respect to the input light beam, for example, phase, frequency, etc. Some input light beam energy may be lost, e.g., reflected, deflected, or diffracted at undesired angles. In some embodiments, some or all of the waveguide is transparent. In some embodiments, a waveguide may be configured to receive input light at an input aperture and output a substantial portion of the received light at an output aperture.

As used herein, “aperture” may refer to an opening through which light passes in optical apparatuses. Some embodiments of waveguides in the present invention include input apertures, through which light may enter, and output apertures, through which light may exit, wherein the output aperture may be substantially larger than the input aperture.

As used herein, “coaxial” may refer to objects or directions/vectors, which share, or lie along, a common axis. For example, three objects in a line may be coaxial (e.g., an axis could be drawn between them). By way of another example, two parallel and overlapping beams of light may be coaxial. For example, if an incident beam of light is reflected at approximately 90 degrees to a surface, the reflected beam of light may be coaxial with the incident beam of light. In the context of the present invention, an optical device may allow for coaxial illumination, if a line of sight of the device (e.g., that of a camera) lies along the same axis as an axis of illumination (e.g., an axis defining an emitted light beam).

As used herein, “light” or “illumination” may in general, refer to any wave of the electromagnetic spectrum. In some embodiments, “light” or “illumination” may be used to refer to visible light, infrared, ultra-violet, microwaves, and/or radio waves.

Where reference numerals are shared between figures, this may indicate that the indicated features are the same as, are similar to, or are related in function to features in other figures which share the same reference numeral.

Some aspects of the invention may be directed to a method of illuminating an object along an optical axis defined by optical elements of an optical device (or otherwise defined by energy focusing elements of an electromagnetic device), wherein the method may include: directing the optical/electromagnetic axis of the optical/electromagnetic device at the object; placing a beam expanding planar waveguide between the optical/electromagnetic device and the object; and directing a light/electromagnetic beam of an illumination/electromagnetic source at the beam expanding planar waveguide at an entrance aperture thereon, such that the beam expanding planar waveguide transmits a significant portion of the energy of said light/electromagnetic beam onto the object along the optical/electromagnetic axis of the optical/electromagnetic device.

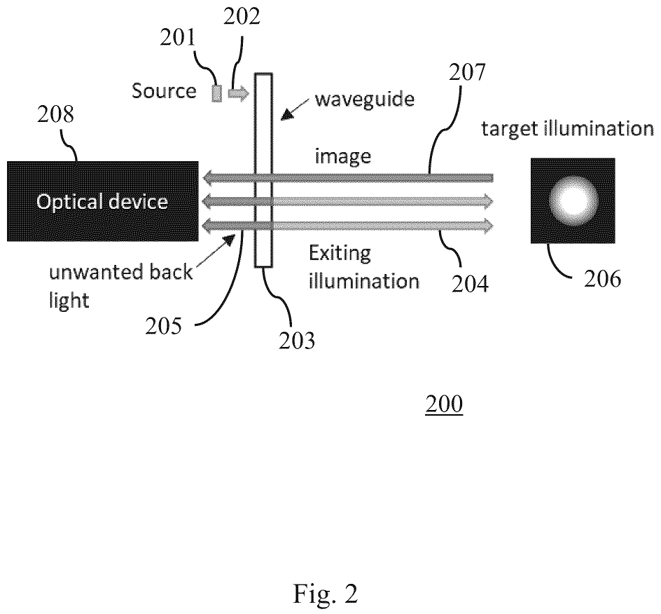

In some embodiments, the beam expanding planar waveguide is placed between the optical/electromagnetic device and the object at a first angle with respect to the optical/electromagnetic axis, the light beam of the illumination/electromagnetic source is directed at the beam expanding planar waveguide at a second angle with respect to the optical/electromagnetic axis, and the first angle and the second angle are selected such that most of the energy of the light/electromagnetic beam reflected backwards by the beam expanding planar waveguide is diverted away from the optical/electromagnetic device. For example, see FIGS. 2-5.

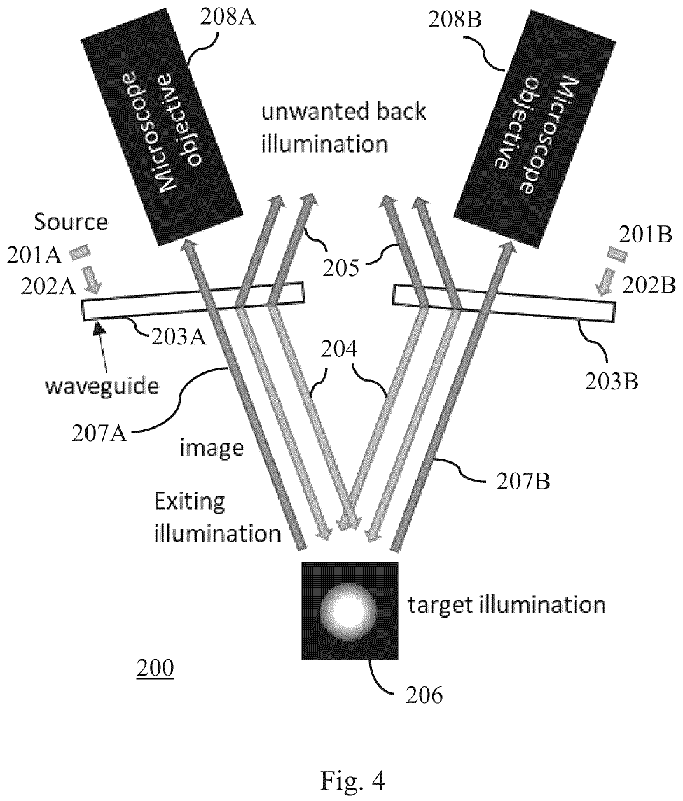

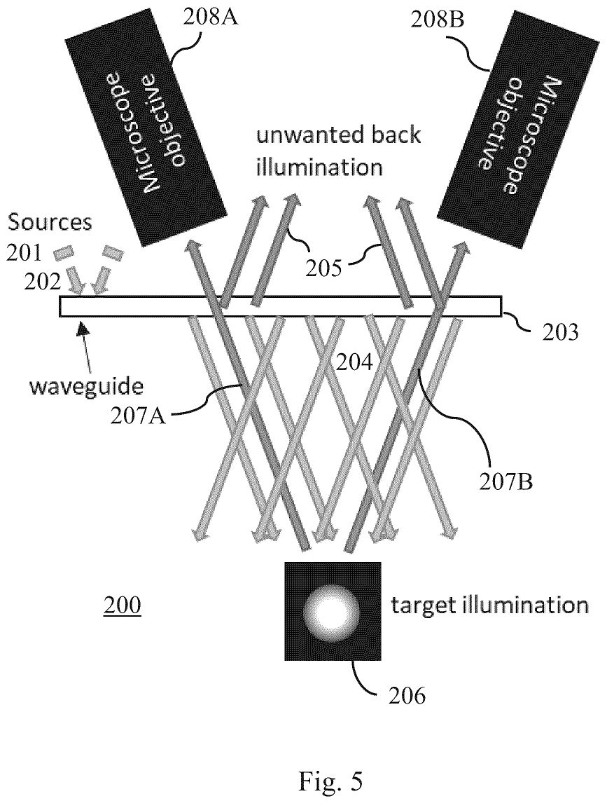

In some embodiments, the method may further comprise directing an additional axis of an additional optical/electromagnetic device at the object, wherein the additional axis is at an angle with respect to the optical/electromagnetic axis and associated with a corresponding second light source directed along said additional optical axis. For example, see FIGS. 4-5.

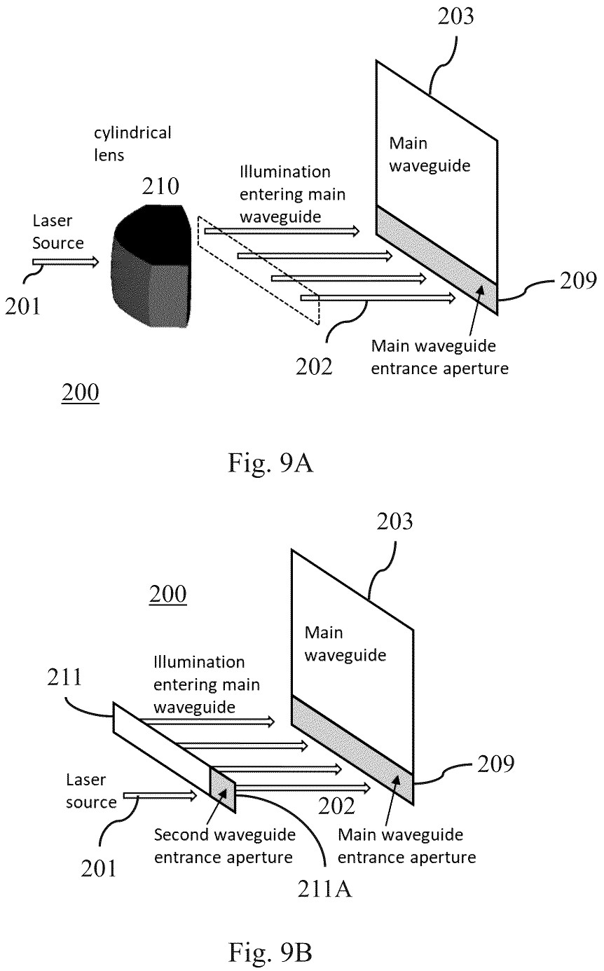

In some embodiments, the method may further include expanding, using at least one first optical element, a width of the light/electromagnetic beam of the illumination/electromagnetic source. For example, see FIG. 9A.

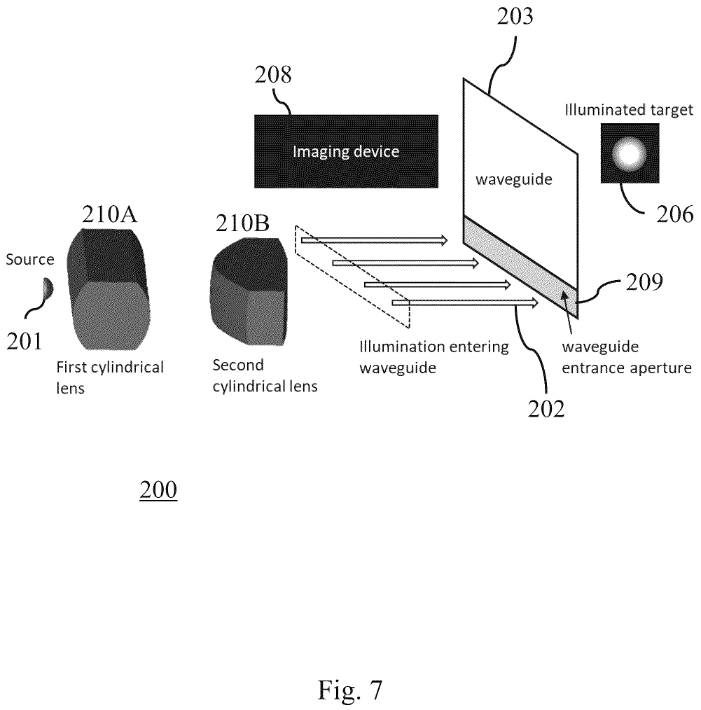

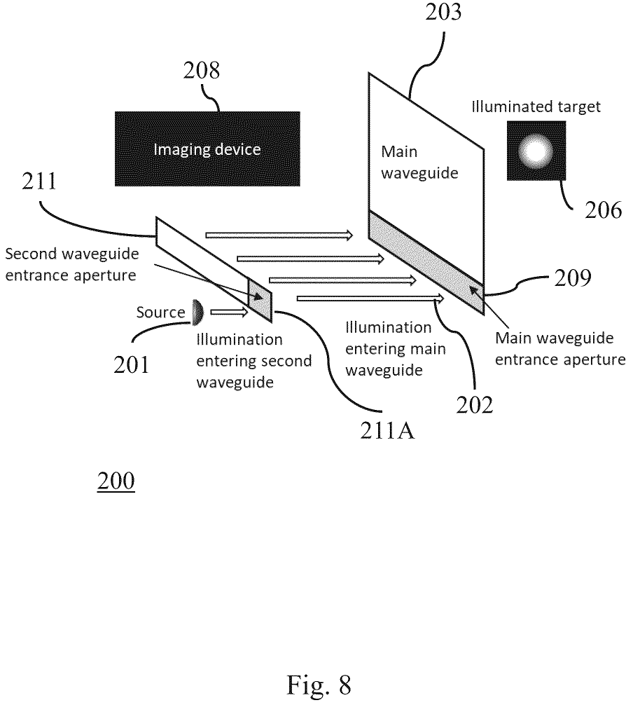

In some embodiments, the method may further include collimating, using at least one second optical element, the light/electromagnetic beam of the illumination/electromagnetic source. For example, see FIGS. 7-8.

In some embodiments, the method may further include expanding the light/electromagnetic beam of the illumination source by directing the light/electromagnetic beam of the illumination/electromagnetic source at an entrance aperture of an auxiliary beam expanding planar waveguide, the auxiliary beam expanding planar waveguide configured to transmit a significant portion of the energy of said light/electromagnetic beam onto the entrance aperture of the (original) beam expanding planar waveguide. For example, see FIGS. 8 and 9B.

In some embodiments, the illumination source is a laser or maser. For example, see FIGS. 9A-9B.

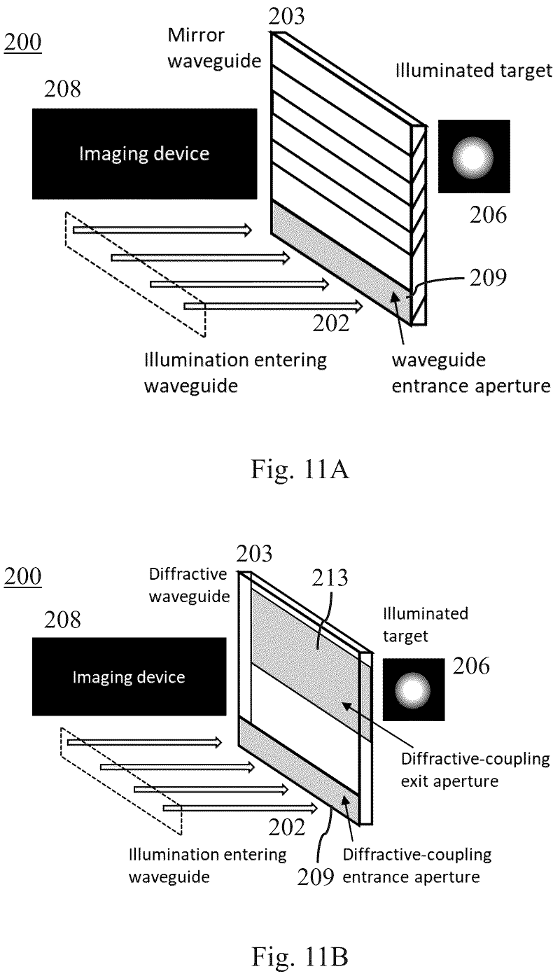

In some embodiments, the beam expanding planar waveguide comprises a series of partially reflective internal mirrors. For example, see FIG. 11A.

In some embodiments, the beam expanding planar waveguide comprises an exit aperture comprising a diffractive microstructure. In some embodiments the entrance can also be diffractive. For example, see FIG. 11B.

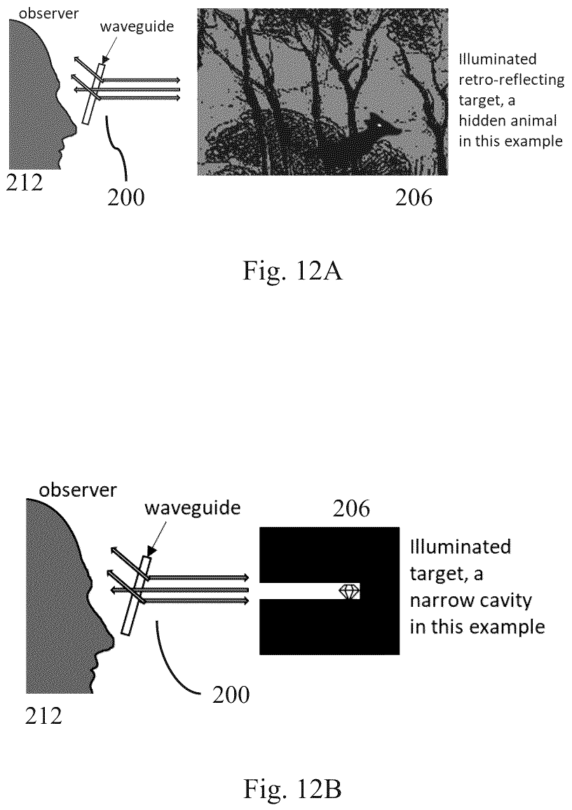

In some embodiments, the optical device comprises at least one of the following: a telescope, a loupe, an eyepiece, a microscope objective, a lens, an imaging device, and an electromagnetic receiver. For example, see FIGS. 12A-16B.

Some aspects of the invention may be directed to a coaxial illumination system, which may comprise: an optical device having optical elements defining an optical axis, said optical device being directed at an object located along the optical axis; a beam expanding planar waveguide placed between the optical device and the object; and an illumination source configured to direct a light beam at the beam expanding planar waveguide at an entrance aperture thereon, such that the beam expanding planar waveguide transmits a significant portion of the energy of said light beam onto the object along the optical axis of the optical device.

In some embodiments, the beam expanding planar waveguide is placed between the optical device and the object at a first angle with respect to the optical axis, the light beam of the illumination source is directed at the beam expanding planar waveguide at a second angle with respect to the optical axis, and the first angle and the second angle are selected such that most of the energy of the light beam reflected backwards by the beam expanding planar waveguide is diverted away from the optical device. For example, see FIGS. 2-5.

In some embodiments, the system may further comprise: an additional optical device having optical elements defining an additional optical axis, said additional optical device being directed at the object located along the additional optical axis, wherein the additional optical axis is at an angle with respect to the optical axis and associated with a corresponding second light source directed along said additional optical axis. For example, see FIGS. 4-5.

In some embodiments, the system may further comprise at least one first optical element configured to expand a width of the light beam of the illumination source. For example, see FIG. 9A.

In some embodiments, the system may further comprise at least one second optical element configured to collimate the light beam of the illumination source. For example, see FIGS. 7-8.

In some embodiments, the system may further comprise an auxiliary beam expanding planar waveguide configured to expand the light beam of the illumination source which is directed at an entrance aperture of said auxiliary beam expanding planar waveguide, and transmit a significant portion of the energy of said light beam onto the entrance aperture of the beam expanding planar waveguide. For example, see FIGS. 8 and 9B.

In some embodiments, the illumination source may be a laser or maser. For example, see FIGS. 9A-9B.

In some embodiments, the beam expanding planar waveguide comprises a series of partially reflective internal mirrors. For example, see FIG. 11A.

In some embodiments, the beam expanding planar waveguide comprises an exit aperture comprising a diffractive microstructure. The entrance can also be diffractive. For example, see FIG. 11B.

In some embodiments, the optical device comprises at least one of the following: a telescope, a loupe, an eyepiece, a microscope objective, a lens, an imaging device, and an electromagnetic receiver. For example, see FIGS. 12A-16B.

FIG. 2 shows a coaxial illumination device 200 according to some embodiments of the present invention (e.g., a standard embodiment). The device may include a light source 201 (e.g., a light bulb, a laser, a lamp, etc.), configured to emit light 202 towards or into a planar optical element or waveguide 203. The light or input light 202 may be substantially collimated. Light may be emitted from each side of the waveguide. Said emitted light may be emitted in a desired direction, i.e., useful light emission 204, or may be emitted in an undesired direction, i.e., unwanted back light 205. Each light emission may be in a direction that is substantially parallel to the direction of emission of the input light 202. Useful light emission 204 may travel towards an object and/or target. Some, all, or none of the useful light emission may reflect off the object and/or target. Some, all, or none of the reflected light may be reflected light 207 that is directed towards the device. Some or all of said reflected light that is directed towards the device may be transmitted through the waveguide to an optical device 208, e.g., a camera or a CCD. In some embodiments, the planar waveguide may lie in a plane that is perpendicular to an axis linking the target and the optical device.

The proposed device may incorporate a planar optical element or waveguide 203 for coaxial illumination of the image of an optical device, in order to overcome the aforementioned disadvantages of coaxial illumination. The planar optical element may be a beam expanding planar waveguide. A beam expanding waveguide may expand a small entrance aperture to a single large optical aperture, in a small volume. It may collect light from a source with a small aperture and translate or expand said light to a second exit aperture directed towards the target to be illuminated. The exit aperture may be placed in front of the optical device and may be highly transparent, thus enabling the exiting light to be coaxial with the optical device's line of sight. A significant portion (e.g. 25%) of the energy of said light beam may be transmitted by the planar waveguide onto the object and/or target along the optical axis of the optical device.

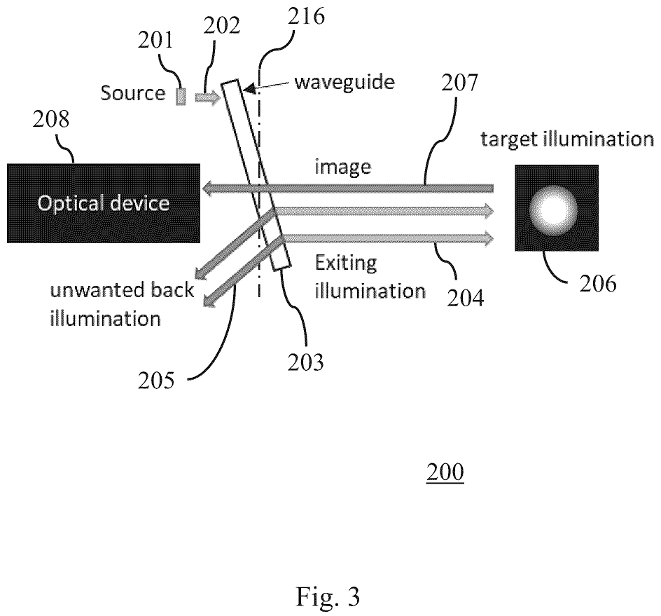

FIG. 3 shows an alternative coaxial illumination device 200 according to some embodiments of the present invention (angled waveguide embodiment). The features of this embodiment may be, unless otherwise stated, substantially similar to those disclosed with respect to FIG. 2. In this alternative embodiment, waveguide 203 may be disposed at an angle to a plane 216 that is perpendicular to an axis linking the target and the optical device. The angle may be referred to as a tilting angle. In other words, the planar waveguide may not be fully perpendicular to the longitudinal axis of device 200. Light source 201 may still emit light 202 that is aligned with the longitudinal axis of device 200. Therefore, useful light emission 204 may travel towards an object and/or target, at which, the device 200 is pointed or aimed. However, because of the waveguide's 203 angle to the plane 216, unwanted back light 205 may be emitted away from a longitudinal axis along which the useful light emission travels. The unwanted backlight may therefore be directed outside the field of view of the optical device 208.

Placing of the beam expanding planar waveguide between the optical device and the object may carried out at a first angle, and directing the light beam of the illumination source at the beam expanding planar waveguide may be carried out at a second angle, wherein the first angle and the second angle are selected such that most of the energy of the light beam reflected back by the beam expanding planar waveguide is diverted away from the optical device.

While FIG. 2 shows the source emitting light that is parallel to an axis defined by optical elements of an optical device, this may not necessarily be the case for different embodiments of waveguide. It may be important that exiting illumination is coaxial to an axis defined by optical elements of an optical device, but it may not be important that light emitted by the light source is coaxial or parallel to said axis.

The embodiment of FIG. 2 may reduce the unwanted portion of light reflected directly from the waveguide to the optical device, which interferes with the image. It may direct said portion of the light away from the optical device by tilting the waveguide with respect to the optical device line of sight, while simultaneously tilting the light source with respect to the waveguide, in such a way that the illumination is coaxial with the optical device, but the unwanted reflection from the waveguide is directed outside the field of view of the optical device. In one preferred embodiment, the tilting angle is one quarter of the field of view of the optical device. In one embodiment, the tilting angle is one quarter of the field of view of the optical device.

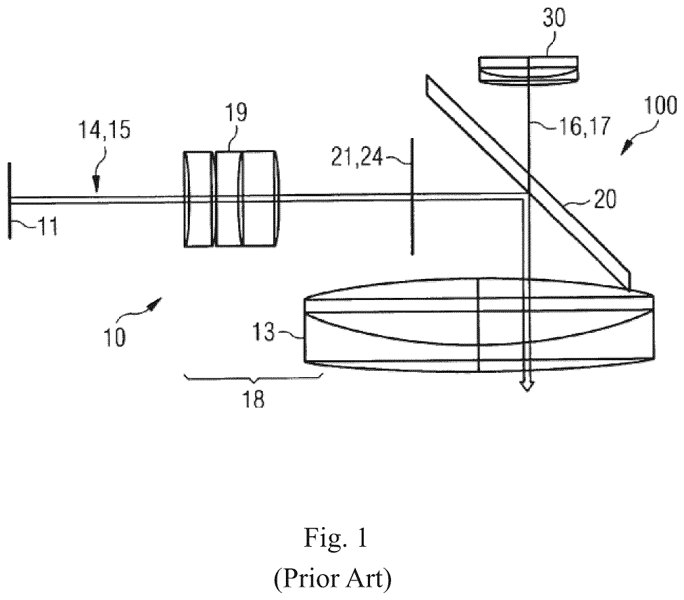

FIG. 4 shows an alternative coaxial illumination device 200 according to some embodiments of the present invention (e.g., a stereo-microscope embodiment). In this embodiment, there may be two light sources 201A & 201B, each configured to emit directional light 202A & 202B at their respective planar waveguides 203A & 203B. Each waveguide may correspond to a respective microscope channel or objective 208A & 208B. Microscope channels/objectives 208A & 208B may include lenses, optical elements, eyepieces, cameras, etc. Each set of equipment A & B may share a common target object 206. Each waveguide may lie in a plane that is perpendicular to an axis linking the target and the microscope objective (e.g., such as in FIG. 1), or each waveguide may be disposed at an angle to said plane (e.g., such as in FIG. 2). The light emitted by each source may be parallel to the axis linking the target and the microscope objective.

A stereomicroscope may be built with this embodiment, having two separate microscope channels with two separate beam expanding planar waveguide illumination systems, wherein each of said illumination systems is coaxial with one of the microscope channels.

FIG. 5 shows an alternative coaxial illumination device 200 according to some embodiments of the present invention (one waveguide stereomicroscope embodiment). This embodiment may e.g., as in FIG. 4, include two microscope channels or objectives 208A & 208B. This embodiment may (e.g., as in FIG. 4) include two directional light sources 201, each emitting light 202 in a separate direction, wherein each said separate direction may be parallel to one of the two axes linking a target 206 and each microscope objective 208A & 208B. The waveguide may consequently emit light in two directions corresponding to each light source, wherein each direction allows for coaxial illumination of the target with respect to one of the microscope objectives. The singular waveguide of FIG. 5 is at an angle to the planes that are perpendicular to each axis linking the target and each microscope objective.

A stereomicroscope may also be built with this embodiment, having two separate microscope channels with two separate beam expanding planar waveguide illumination systems, wherein each of said illumination systems is coaxial with one of the microscope channels.

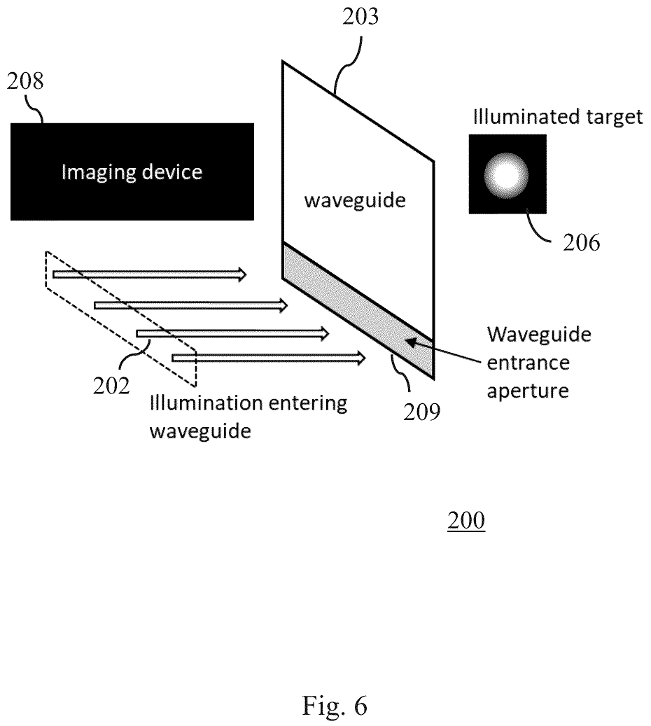

FIG. 6 shows a coaxial illumination device 200, with a view of a waveguide entrance aperture 209, according to some embodiments of the present invention. An entrance aperture may be an opening through which light enters the waveguide 203. For optimal function of the waveguide, e.g., to ensure that light is output evenly (e.g., over an exit or output aperture), it may be required that light is input across substantially the whole entrance aperture. For reasons of providing coaxial illumination, it may be required that the input light is substantially collimated and aligned in a specific direction, such as parallel to an axis linking a target 206 to an imaging device 208 (e.g., as discussed elsewhere). It may therefore be optimal to provide collimated light 202 across substantially all the waveguide entrance aperture. The input light 202 may be required to be uniform. The entrance aperture may for example, be rectangular. It may be elongated (e.g., its length may be more than twice its width).

FIG. 7 shows a coaxial illumination device 200, with a view of a waveguide entrance aperture 209, according to some embodiments of the present invention. As discussed with respect to FIG. 6, it may be optimal to provide uniform illumination, e.g., collimated light 202 across substantially all the waveguide entrance aperture. FIG. 7 gives a means of providing uniform illumination. Light may be emitted by a light source 201 (e.g., filament bulb, LED, etc.). Said light may be uncollimated. The uncollimated light may spread out for a distance. It may then interact with a number of optical elements, for example, lenses. For example, there may be two optical elements 210A & 210B which may be cylindrical or toroidal lenses, which may act to collimate the uncollimated light. In the case of cylindrical lenses, each may have a cylindrical axis that is perpendicular to the desired direction of the collimated light and also perpendicular to the cylindrical axis of the other cylindrical lens. For example, with respect to FIG. 7, the first cylindrical lens may collimate the light in a first direction/axis (e.g., vertical), and the second cylindrical lens may collimate the light in a second direction/axis (e.g., horizontal). Where the waveguide entrance aperture is particularly elongated (e.g. substantially longer in the second direction than in the first), it may be optimal to collimate the light in the first direction earlier than in the second direction, in order that the light continues to spread out in the second direction for longer, thereby providing uniform illumination across substantially all the waveguide entrance aperture. This construction may allow for high efficiency of the source and uniformity of the illumination.

FIG. 8 shows a coaxial illumination device 200, with a view of a waveguide entrance aperture 209, according to some embodiments of the present invention. FIG. 8 may form an alternative embodiment to that of FIG. 7. As discussed with respect to FIG. 6, it may be optimal to provide uniform illumination, e.g., collimated light 202 across substantially all the waveguide entrance aperture. This embodiment may include a second waveguide 211, with its own respective second waveguide entrance aperture 211A. The second waveguide may be of a size such that its exit aperture is of substantially the same size as the main entrance aperture 209 of the main waveguide 203. A light source 201 may illuminate the second waveguide entrance aperture. The second waveguide may output the input light across its entire exit aperture. This light may then travel (the two waveguides may be separated or may be in contact) to the main waveguide, which may be aligned such that the light exiting the second waveguide may enter the main entrance aperture of the main waveguide. The main waveguide may then output the input light across its entire exit aperture (e.g., towards the target 206). The source 201 may emit collimated light, or the second entrance aperture may be sufficiently small compared to the source and the distance of the source from the aperture, that the input light is effectively collimated light. This construction may allow for high efficiency of the source and uniformity of the illumination.

FIGS. 9A and 9B show beam expansion apparatuses which include lasers according to some embodiments of the present invention. FIG. 9A may be similar, in some respects, to FIG. 7. The apparatus of FIG. 9A includes a light source which emits a collimated light beam from a laser emitter. The laser beam does not require collimating (e.g., as in FIG. 7), however, it may require expansion (e.g., the beam must be made wider). The apparatus of FIG. 9A may include a lens 210 (e.g., cylindrical and/or toroidal) configured to expand (and then recollimate) the light beam, to give an expanded collimated beam 202. FIG. 9B may be much the same as that of FIG. 8. In the apparatus of FIG. 9B, the light source 201 is a laser emitter, which ensures that the light that enters the beam expansion apparatus is collimated. That a laser emitter provides light that is collimated may be particularly advantageous with respect to both embodiments of FIGS. 9A and 9B, in order to provide coaxial illumination of a target. Another advantage of using a laser source is that laser light has a high energy intensity/brightness. This high intensity may be particularly optimal to provide sufficient brightness to the target, once the light input has been spread out over the whole area (e.g., exit aperture) of the main waveguide 203.

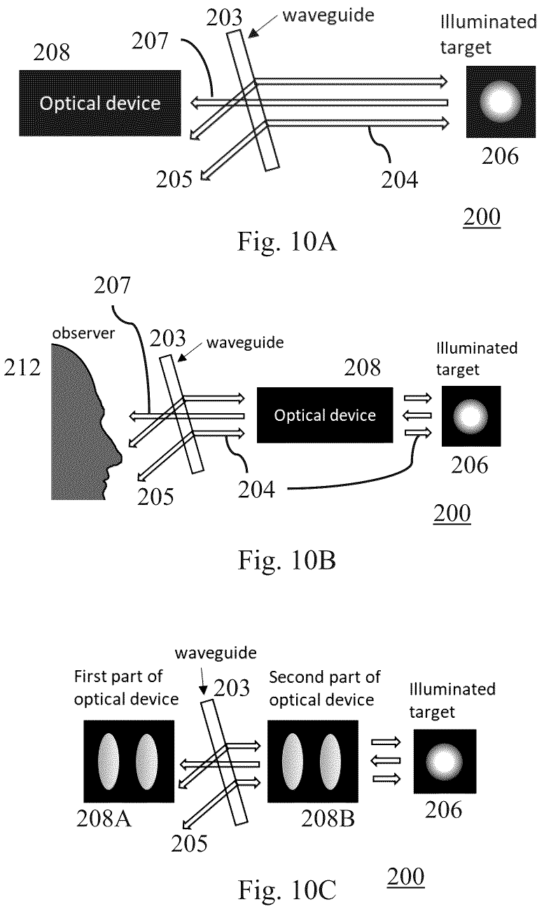

FIGS. 10A, 10B, and 10C show a number of coaxial illumination devices with different relative positions of the optical device 208 (e.g., camera, CCD, etc.) with respect to the waveguide 203 (or vice versa). In FIG. 10A, the optical device may be placed further from the target than the waveguide (e.g., as shown previously). In FIG. 10B, the optical device may be placed closer to the target than the waveguide. FIG. 10B also shows an observer who may directly view light 207 reflected from the target. Advantageously, the embodiments of described in FIG. 10B serve an alternative configuration that can save even more space and can be desirable in some applications.

In FIG. 10C, the waveguide may be placed within or incorporated within the optical device. In other words, waveguide 203 may be placed between the first part of the optical device 208A and a second part of the optical device 208B. This embodiment may ensure that light returning from the target (image light rays) is collimated or nearly collimated (e.g., due to passing through the second part of the optical device 208B, which may comprise optical elements).

FIGS. 11A and 11B show examples of waveguides according to some embodiments of the present invention. FIG. 11A shows a mirror waveguide 203. A mirror waveguide may comprise a first aperture mirror, configured to reflect the light into the waveguide, as well as a series of partially reflective output mirrors, each configured to reflect a portion of the light which is incident upon them out of the waveguide in a direction parallel to the light which entered the waveguide aperture. In some embodiments, each partially reflective mirror may increase in reflectivity, the further the partially reflective mirror is from the waveguide entrance aperture. This may ensure an even output of light. A mirror waveguide may expand a small beam into a larger beam with high efficiency and high transmission. FIG. 11B shows a diffractive waveguide 203. A diffractive waveguide may perform substantially the same function as the mirror waveguide, however, instead of using mirrors, the face of the waveguide is ridged with a diffractive microstructure which couples the light to the target. The transmission and efficiency of a diffractive waveguide are also high.

FIGS. 12A and 12B show naked-eye illumination devices according to some embodiments of the present invention. The device 200 of FIGS. 12A and 12B may be substantially similar to devices discussed elsewhere (e.g., FIGS. 2-5), however, naked-eye illumination devices may not include the imaging device of these embodiments (e.g., as referred to with 208). However, the naked-eye illumination devices could be said to include an imaging device in that they may include an eyepiece and/or container for the device 200. In naked-eye illumination devices, an observer 212 may observe the reflected light directly (or through one or more optical elements). FIG. 12A shows an example in the context of hunting or searching for animals with retroreflecting eyes 206 (i.e., the target may be animals or their eyes). The naked-eye illumination device 200 therein may for example, be incorporated into a device with some magnification, e.g., binoculars or a scope, or may be a standalone device. FIG. 12B shows an example in the context of examining or inspecting narrow cavities. This example allows a user to see into a narrow cavity which has been illuminated, without some conventional illumination device (e.g., as may be known in the art) being used, which may illuminate the cavity, but would also block a line of sight into the cavity.

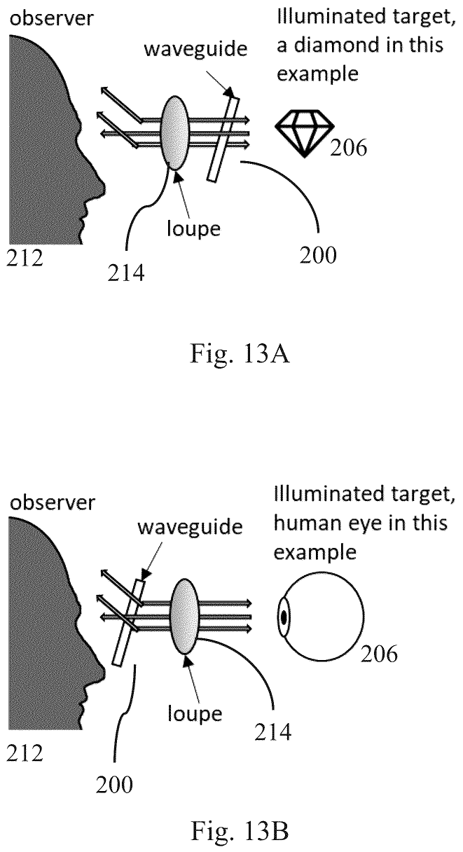

FIGS. 13A and 13B show loupe illumination devices according to some embodiments of the present invention. The device 200 of FIGS. 13A and 13B may be substantially similar to devices discussed elsewhere (e.g., FIGS. 2-5, 12A, and 12B), however loupe illumination devices may include a loupe, magnifying lens, or magnification device configured to allow small details to be seen more closely. FIG. 13A shows an example in the context of jewelry inspection, where the target 206 is a jewel, such as a diamond. For example, it may be beneficial to utilize collimated light in this context, as this may improve the detection of defects in the jewel. FIG. 13B shows an example in the context of ophthalmology. As discussed elsewhere, the present invention may be particularly advantageous for viewing the retina of a patient's eye. It may be additionally advantageous to magnify the resulting image of a patient's retina, in order to increase the effectiveness of utilizing the present invention in assessing the health of a patient's eye; this may be achieved with a loupe or magnifying lens.

One possible difference illustrated by FIGS. 13A and 13B is that FIG. 13A shows an embodiment in which the loupe is further from the target than the waveguide, and FIG. 13B shows an embodiment in which the loupe is closer to the target than the waveguide. This difference is merely exemplary, and neither embodiment should be excluded from use in the context of the other. Neither of FIGS. 13A and 13B depict an imaging device (e.g., as discussed elsewhere), however, one may be incorporated if required.

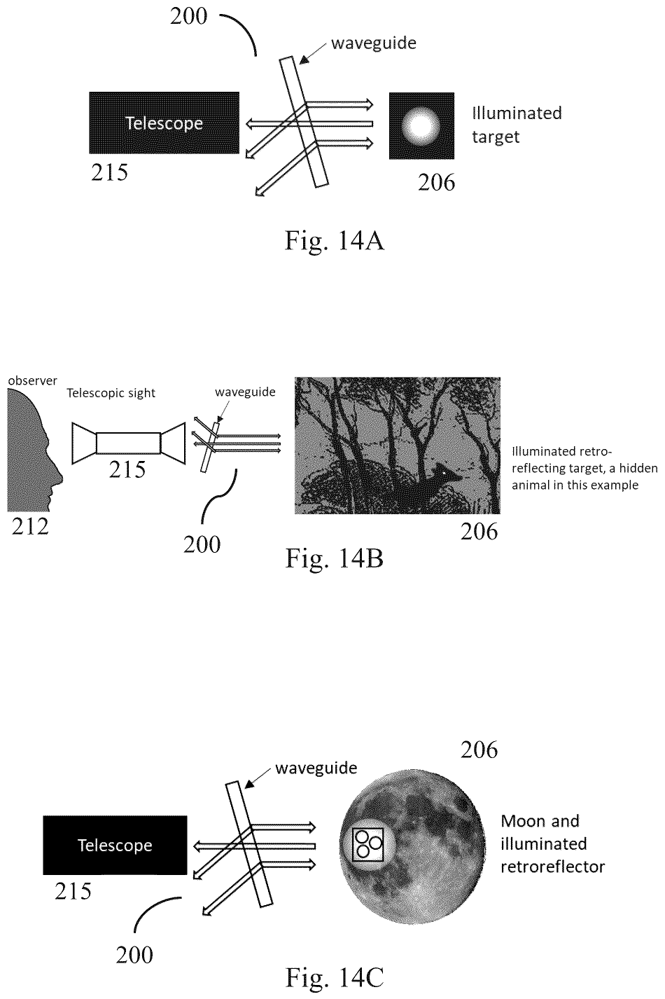

FIGS. 14A, 14B, and 14C show telescopic illumination devices according to some embodiments of the present invention. The device 200 of FIGS. 14A, 14B, and 14C may be substantially similar to devices discussed elsewhere (e.g., FIGS. 2-5, 12A, and 12B), however telescopic illumination devices may include a telescope 215, or magnification device configured to magnify light traveling from distant objects. FIG. 14A shows an example embodiment of a telescopic illumination device, comprising a coaxial illumination device 200, aimed at a target 206, wherein any imaging device (e.g., often referred to with 208) is, or has been replaced with, a telescope 215. A user may be able to view a target through the telescope, wherein the target has been illuminated with coaxial collimated light. FIG. 14B shows an example embodiment of a telescopic illumination device, wherein the target 206 is retroreflecting, for example, the eyes of certain species of animal, a safety jacket, a license plate, or an optical device. FIG. 14B also shows a user 212 looking through the telescope. The telescope may be, or be incorporated into, a sight, a scope, a pair of binoculars, etc. FIG. 14C shows a further example embodiment of a telescopic illumination device being used in an astronomical context. The target 206 may be extraterrestrial, for example, an extraterrestrial retroreflector (e.g., on the moon).

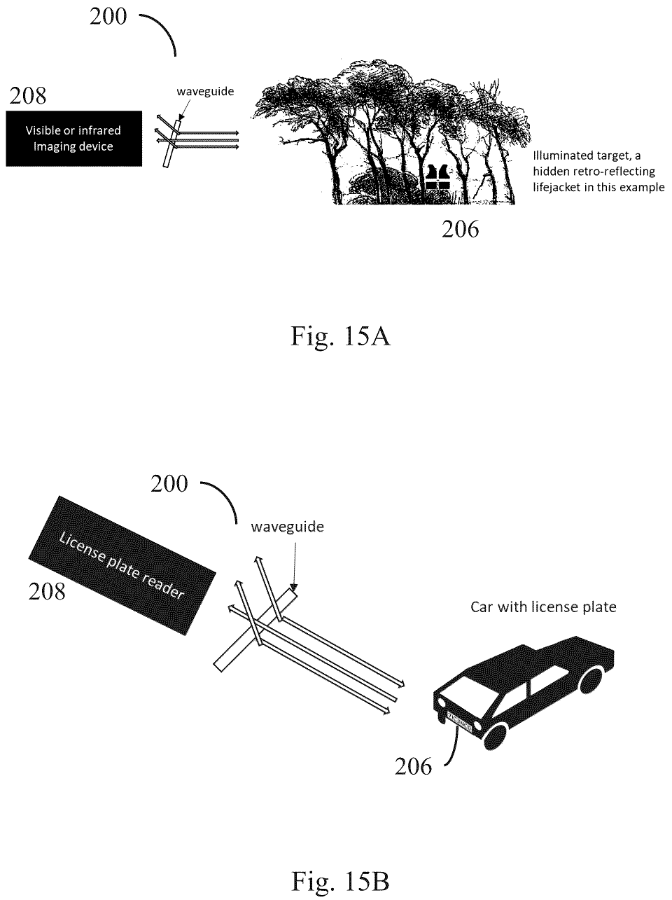

FIGS. 15A and 15B show example use cases of coaxial illumination devices 200 according to some embodiments of the invention. Both examples exploit the properties of retroreflectors, which are particularly relevant in the context of the present invention. A retroreflector is a device which reflects light along the same axis along which the incident light arrived. A beam of collimated light incident on a retroreflector would be reflected ‘back the way it came’. In other words, the incident light and the reflected light are coaxial. Given, in the present invention, the optical device 208 (or equivalent) is coaxial with the emitted beam of light, the reflected light will be focused directly into the optical device, resulting in the retroreflector being particularly bright and visible using the present invention.

FIG. 15A shows a coaxial illumination device being used in the context of search and rescue. Various items of clothing, for example, high-visibility vests and lifejackets, comprise retroreflectors. This property may be utilized by the coaxial illumination devices of the present invention, to improve visibility of those in need of search and rescue; if a coaxial illumination device is pointed at a clothing retroreflector, the reflection will be particularly bright, as seen by the device. FIG. 15B shows a coaxial illumination device being used in the context of reading/recognizing license plates. License plates, may in some jurisdictions, comprise retroreflectors. This property may be utilized by the coaxial illumination devices of the present invention, to improve visibility of license plates when viewed with said coaxial illumination devices. This improved visibility may for example, improve the detection of license plate numbers by a license plate reader. Each of FIGS. 15A and 15B may include optical elements, such as telescopes to improve their function, as required.

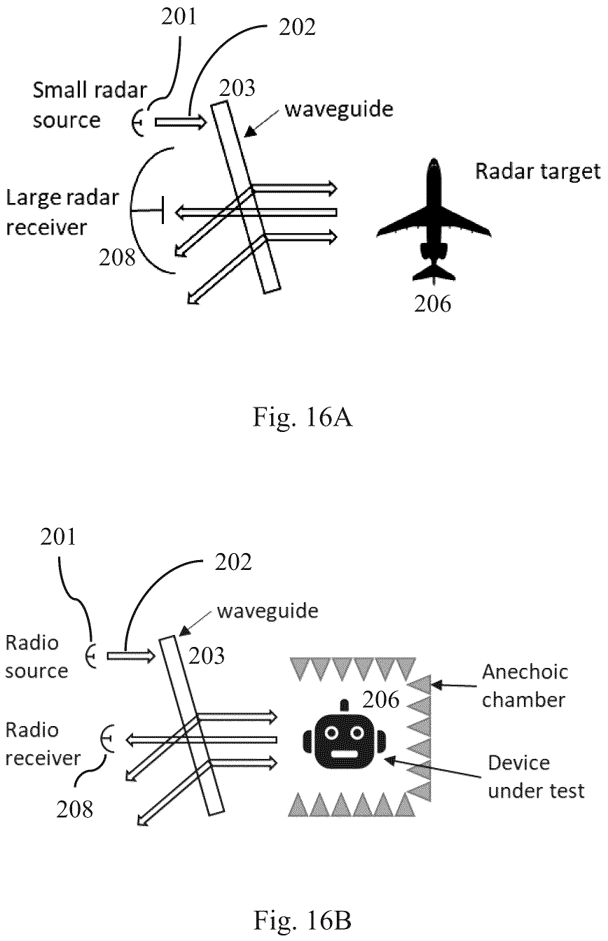

FIGS. 16A and 16B show coaxial radar and/or radio devices according to some embodiments of the present invention. The device 200 of FIGS. 16A and 16B may be substantially similar to devices discussed elsewhere (e.g., FIGS. 2-5), however, the light source may comprise a radar/radio source 201 (possibly a small radar source), which emits radio waves 202 into the waveguide 203, and the optical device may comprise a radar/radio receiver (possibly a large radar receiver). For example, the embodiment of FIG. 16A may be used in radar detection and/or localization systems. For example, the target 206 may be a target capable of reflecting radio waves, such as an aircraft or missile. The device may be used to detect the target and/or determine its position/distance from the device. The coaxial nature of the device may lead to greater accuracy over non-coaxial devices. The embodiment of FIG. 16B may be used for testing a device 206. The device may be placed in an anechoic chamber to shield the device from external waves (e.g., electromagnetic or sound). The anechoic chamber may have an opening, and the coaxial radio device may be used to illuminate the device with radio waves and simultaneously receive any reflected radio waves through the opening (e.g., this may be similar to narrow cavity embodiments of FIGS. 12B and 13B).

Systems and methods of the present invention may improve illumination technology by providing coaxial illumination devices and methods, which, for example, have a compact physical size, allow for clear viewing of retroreflectors, are particularly effective at detecting light reflected at 90 degrees, which are particularly effective at viewing targets inside narrow cavities (e.g., looking at a retina through a pupil of an eye), and are particularly effective when searching for targets that comprise retroreflectors (e.g., the eyes of certain animals, and lifejackets).

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of illuminating an object along an optical axis defined by optical elements of an optical device, the method comprising:
directing the optical axis of the optical device at the object;
placing a beam expanding planar waveguide between the optical device and the object; and
directing a light beam of an illumination source at the beam expanding planar waveguide at an entrance aperture thereon, such that the beam expanding planar waveguide transmits a significant portion of the energy of said light beam onto the object along the optical axis of the optical device.

2. The method according to claim 1, wherein:
the beam expanding planar waveguide is placed between the optical device and the object at a first angle with respect to the optical axis,
the light beam of the illumination source is directed at the beam expanding planar waveguide at a second angle with respect to the optical axis, and
the first angle and the second angle are selected such that most of the energy of the light beam reflected backwards by the beam expanding planar waveguide is diverted away from the optical device.

3. The method according to claim 1, further comprising:
directing an additional optical axis of an additional optical device at the object, wherein the additional optical axis is at an angle with respect to the optical axis and associated with a corresponding second light source directed along said additional optical axis.

4. The method according to claim 1, further comprising at least one of:
expanding, using at least one first optical element, a width of the light beam of the illumination source; and
collimating, using at least one second optical element, the light beam of the illumination source.

5. The method according to claim 1, further comprising:
expanding the light beam of the illumination source by directing the light beam of the illumination source at an entrance aperture of an auxiliary beam expanding planar waveguide, the auxiliary beam expanding planar waveguide configured to transmit a significant portion of the energy of said light beam onto the entrance aperture of the beam expanding planar waveguide.

6. The method according to claim 1, wherein the illumination source is a laser.

7. The method according to claim 1, wherein the beam expanding planar waveguide comprises a series of partially reflective internal mirrors.

8. The method according to claim 1, wherein the beam expanding planar waveguide comprises an exit aperture comprising a diffractive microstructure.

9. The method according to claim 1, wherein the optical device comprises at least one of:
a telescope;
a loupe;
an eyepiece;
a microscope objective;
a lens; and
an imaging device.

10. A coaxial illumination system comprising:
an optical device having optical elements defining an optical axis, said optical device being directed at an object located along the optical axis;
a beam expanding planar waveguide placed between the optical device and the object; and
an illumination source configured to direct a light beam at the beam expanding planar waveguide at an entrance aperture thereon, such that the beam expanding planar waveguide transmits a significant portion of the energy of said light beam onto the object along the optical axis of the optical device.

11. The system according to claim 10, wherein:
the beam expanding planar waveguide is placed between the optical device and the object at a first angle with respect to the optical axis,
the light beam of the illumination source is directed at the beam expanding planar waveguide at a second angle with respect to the optical axis, and
the first angle and the second angle are selected such that most of the energy of the light beam reflected backwards by the beam expanding planar waveguide is diverted away from the optical device.

12. The system according to claim 10, further comprising:
an additional optical device having optical elements defining an additional optical axis, said additional optical device being directed at the object located along the additional optical axis, wherein the additional optical axis is at an angle with respect to the optical axis and associated with a corresponding second light source directed along said additional optical axis.

13. The system according to claim 10, further comprising at least one of:
at least one first optical element configured to expand a width of the light beam of the illumination source; and
at least one second optical element configured to collimate the light beam of the illumination source.

14. The system according to claim 10, further comprising:
an auxiliary beam expanding planar waveguide configured to:
expand the light beam of the illumination source which is directed at an entrance aperture of said auxiliary beam expanding planar waveguide, and
transmit a significant portion of the energy of said light beam onto the entrance aperture of the beam expanding planar waveguide.

15. The system according to claim 10, wherein the illumination source is a laser.

16. The system according to claim 10, wherein the beam expanding planar waveguide comprises a series of partially reflective internal mirrors.

17. The system according to claim 10, wherein the beam expanding planar waveguide comprises an exit aperture comprising a diffractive microstructure.

18. The system according to claim 10, wherein the optical device comprises at least one of:
a telescope;
a loupe;
an eyepiece;
a microscope objective;
a lens;
an imaging device, and
an electromagnetic receiver.

19. A method of illuminating an object along an axis defined by energy focusing elements of an electromagnetic device, the method comprising:
directing the axis of the electromagnetic device at the object;
placing a beam expanding planar waveguide between the electromagnetic device and the object; and
directing an electromagnetic beam of an electromagnetic source at the beam expanding planar waveguide at an entrance aperture thereon, such that the beam expanding planar waveguide transmits a significant portion of the energy of said electromagnetic beam onto the object along the axis of the electromagnetic device.

20. The method according to claim 19, wherein:
the beam expanding planar waveguide is placed between the electromagnetic device and the object at a first angle with respect to the axis of the electromagnetic device,
the electromagnetic beam of the electromagnetic source is directed at the beam expanding planar waveguide at a second angle with respect to the axis of the electromagnetic device, and
the first angle and the second angle are selected such that most of the energy of the electromagnetic beam reflected backwards by the beam expanding planar waveguide is diverted away from the electromagnetic device.
